(19) United States
(12) Patent Application Publication
(10) Pub. No.: US 2002/0057570 A1
(43) Pub. Date: May 16, 2002

(54) Lighting system and lamp-reflector unit

(75) Inventor: Paulus Bartholomeus Johannes Schaareman, Eindhoven (NL)

Correspondence Address: Corporate Patent Counsel, U.S. Philips Corporation, 580 White Plains Road, Tarrytown, NY, 10591, US

(73) Assignee: Koninklijke philips Electronics N.V.

(21) Appl. No.: 10/014,858

(22) Filed: Nov. 13, 2001

(30) Foreign Application Priority Data
Nov. 14, 2000 (EP) 00203994.9

(51) Int. Cl. F21V 9/00

(52) U.S. Cl. 362/296

(57) ABSTRACT

The invention relates to a lighting system (1) comprising a lamp-reflector unit (2) in a housing (5), the housing (5) having air flow cooling means (7) and a ventilation opening (8). The lamp-reflector unit (2) is provided with a shield (9), for example a black coating, for avoiding light originating from the lamp-reflector unit (2) to emit from the housing (5) through its ventilation opening (8) during operation of the lamp (16). Thus a simple and relatively quiet cooling of the lighting system (1) is obtained.

The invention relates to a lighting system comprising:

a lamp-reflector unit comprising:

a reflector body with a reflecting portion having an optical axis, with a light emission window transverse to the optical axis, and with a concave inner reflecting surface and an outer surface;

an electric lamp positioned in the reflecting portion,

a housing accommodating said lamp-reflector unit, an aperture for enabling light originating from the lamp-reflector unit during operation of the lamp to emit from the housing, and air flow cooling means for cooling of the lamp-reflector unit during operation of the lamp, the cooling means comprising a ventilation opening in the housing for enabling cooling air to flow out of the housing;

The invention further relates to a lamp-reflector unit.

Such a lighting system is known from DE-A-3509939, the known lighting system is a projector. In the known lighting system heat is generated by the lamp-reflector unit during operation involving the risk on fire or short-circuiting because of the lamp-reflector unit becoming too hot. Therefore in the housing cooling means are provided. The cooling means forcing cooling air to flow through the lighting system in order to counteract the lighting system to become too hot during operation of the lamp. In the known lighting system a fan is comprised in the cooling means. The cooling means further having a structure causing cooling air to be divided into two parts, one of which runs between two front glass plates placed in front of the reflector body and the other into the reflector body. In the vicinity of the lamp, as part of the cooling means, the ventilation opening is arranged in the housing. The lamp during operation emits light and/or ultraviolet (UV)-radiation in all directions of which a part is effectively used. Another part is unintentionally send into the housing as stray light and/or UV-radiation as a result of its passing through the reflecting portion of the reflector body, and subsequently is lost. It is a disadvantage of the known lighting system that a relatively large amount of stray light and/or UV-radiation can emerge from the housing, for example through the ventilation opening, and thus to be discomforting for the environment. Generally a light shield is positioned in between the lamp-reflector unit and the ventilation opening to counteract this disadvantage. Often louvers or overlapping shields are used for that purpose, however, these cause excessive noise because of air flowing in an excessively turbulent way through it. It is, however, a disadvantage of such a lighting system that the cooling means, comprising such a light shield, cause excessive noise and have a relatively complicated structure.

It is an object of the invention to provide a lighting system in which the abovementioned disadvantages are counteracted. This object is attained by a lighting system of the type as described in the opening paragraph which is characterized in that the lamp-reflector unit is provided with a shield at a side of the reflecting surface facing away from the light emission window and in between the lamp and the ventilation opening. In a preferred embodiment of the lighting system the shield is a coating on the outer surface of the reflector, for example, a black, a white or a metallic coating. In such an embodiment the shield has a simple structure and is easily applicable with use of conventional techniques. Preferably, the coating is a shield for ultraviolet radiation (UV-shield). The UV-shield coating is obtainable from, for example, a paint comprising ethylsilicate or silicon resin with components that absorb UV-radiation, for example titanium oxide and/or cerium oxide particles. In another preferred embodiment the shield is a black coating on the outer surface of the reflector. The black coating is obtainable from, for example, paint comprising ethylsilicate or silicon resin with a mixture of transition metal oxides such as Fe, Mn, Ti, or silicon as a black pigment. Such a black coating reduces the risk of unintentional passing through or reflection of light as it absorbs light instead of reflecting it. The coatings may be provided with a brush, with a printing technique, or by spraying, for example with an ink jet, using for example a suspension or paint as a starting material. Alternatively the shield may be a reflector body made of non-light transmitting, for example black material, made from, for example, ceramic, glass or glass-ceramic. In the inventive lighting system the shield shields that part of the lamp-reflector unit that emits light and/or UV-radiation in undesired directions, for example light and/or UV-radiation that is transmitted through the outer surface of the reflecting portion of the reflector body, for example in the direction of the ventilation opening. The advantage is that shielding is relatively simple because the main part of undesired light and/or UV-radiation is intercepted before it can be scattered. The necessity of a complicated separate shield structure is thus counteracted. In known lighting systems the shield often is a resistance to the airflow, resulting in that the cooling is relatively inefficient and noisy due to excessively turbulent flow of the air. The inventive light system has a further advantage that cooling air can readily flow out of the housing without excessive turbulence, for example because louvers are no longer required, thus a significant reduction in the resistance to the air flow is obtained. Hence not only a significant reduction of noise is obtainable but also a more efficient cooling is enabled thereby.

In another embodiment the lighting system is a projector, for example a light valve projector such as a Liquid Crystal Display (LCD) or a beamer. There is a desire for smaller designs of some lighting systems, at least for projector systems. The substitution in a projector of a separate complicated shield structure that is arranged around the lamp-reflector unit, by a shield provided on the lamp-reflector unit, enables the possibility to design a relatively small shield and thus enables to design relatively small projectors. As the inventive projector has the further advantage that cooling air can readily flow out of the housing and thus enabling a more efficient cooling. Thus the risk of the projector becoming too hot during operation, also because of its relatively small size, is counteracted.

A lamp-reflector unit provided at a side of the reflecting surface facing away from the light emission window with a shield, is suitable for use in a lighting system. Alternatively, the lamp-reflector unit can be used for example for accent lighting under free burning conditions, i.e. without being built inside a housing. Due to the shield provided on the lamp-reflector unit, it is counteracted for light and/or UV-radiation to pass through the outer surface of the reflector body. The light otherwise might be discomforting because of causing glare. The UV-radiation otherwise might be harmful to the human eye. The lamp of said lamp-reflector unit is, for example, a halogen incandescent lamp or a high-pressure discharge lamp having a lamp vessel which, for example, is made of quartz glass, i.e. glass having SiO2 contents of at least 95 percent by weight. Alternatively the lamp vessel may be made of a densely sintered translucent ceramic, for example translucent gastight alumina.

An embodiment of the lighting system of the invention is elucidated schematically in the drawing, in which

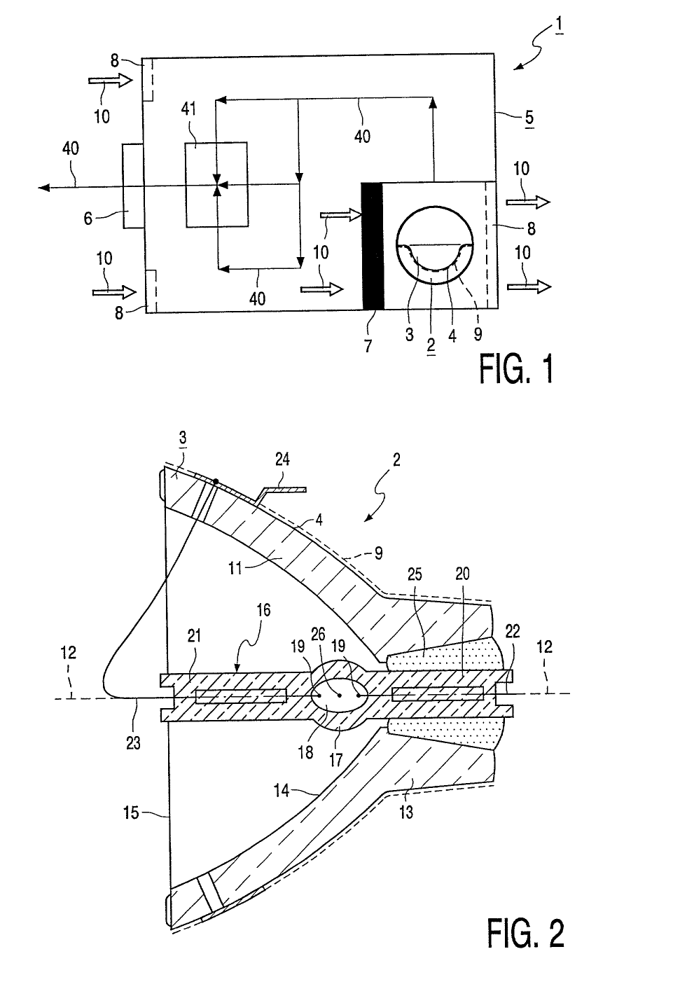

FIG. 1 is a schematic view of a lighting system according to the invention;

FIG. 2 is a cross-section of a lamp-reflector unit suitable for use in a lighting system according to the invention.

The lighting system 1 schematically shown in FIG. 1 is a projector 1, for example for a LCD. The projector 1 comprises a housing 5 accommodating a lamp-reflector unit 2, the lamp-reflector unit 2 comprising a reflector body 3 with an outer surface 4. The housing 5 has an aperture 6 for enabling light beams 40, originating from the lamp-reflector unit 2 during operation and after passing through a mirroring unit 41, to emit from the housing 5. Airflow cooling means 7, in the figure a fan, for cooling of the lamp-reflector unit 2 during operation, is present in the housing 5. The cooling means 7 comprises ventilation openings 8 in the housing 5 for enabling cooling air 10 to flow out of the housing 5. The lamp-reflector unit 2 is provided with a coating 9 on the outer surface 4 of the reflector body 3. The coating 9 acts as a UV-shield and counteracts UV-radiation originating from the lamp-reflector unit 2 to emit from the housing 5 through the ventilation openings 8 during operation as it is positioned in between the lamp 16 and the ventilation opening 8.

The lamp-reflector unit 2 shown in cross-section in FIG. 2 has a reflector body 3 which is provided with a reflecting portion 11 having an optical axis 12 and with a hollow neck-shaped portion 13 surrounding the optical axis 12. The reflecting portion further comprises a concave, for example parabolically or elliptically curved, reflecting inner surface 14 between the neck-shaped portion 13 and a light emission window 15 which is transverse to the optical axis 12. The reflector body 3 has a focus 26 situated within the reflecting portion 11 and on the optical axis 12. In the drawing, the reflector body 3 is made of glass and has as the reflecting inner surface 14 a mirroring layer formed by a metal layer, in the drawing a aluminum metal layer. The outer surface 4 of the reflector body 3 is provided with a black coating 9 to absorb light that has passed through the mirroring layer, thus acting as a light shield. The black coating 9 comprises carbonyl iron with silicon, and is applied from a suspension. The lamp-reflector unit 2 preferably further comprises as a light source an ultra high-pressure mercury vapor discharge lamp 16 with a nominal power of 200 Watt and a pressure of 180 bar or more during operation. The lamp 16 has a lamp vessel 17 which is closed in a gastight manner and is made of quartz glass, but it may alternatively be made of a ceramic material, for example densely sintered aluminum oxide. The lamp vessel 17 has a cavity 18, in which a pair of electrodes 19 in the Figure with an electrode interspacing of between 0.5-1.5 mm, in the drawing with an interspacing of 1 mm, is arranged. The short electrode interspacing yields a short arc during operation of the lamp, as a result said arc is relatively accurately positioned in the focus 26 of the reflector body 3. Consequently the light generated in the arc can be directed accurately and can be used efficiently. The lamp vessel 17 and a first 20 and a second, opposed seal 21, though which seals 20, 21 a respective first 22 and second current conductor 23 connected to the electric element 19 are passed so as to issue from the lamp vessel 17 to the exterior and there being contacted to external contacts 22. A filling is furthermore accommodated in the cavity 18 of the lamp vessel 17, comprising mercury and a rear gas, for example argon, and bromine. The lamp 16 is positioned, in the Figure fixed by means of cement 25, with said seal 20 in the neck-shaped portion 13 of the reflector body 3, with its cavity 18 within the reflecting portion 11, and with the electric element 19 in the focus 26 on the optical axis 12.

1. A lighting system (1) comprising:
a lamp-reflector unit (2) comprising:
a reflector body (3) with a reflecting portion (11) having an optical axis (12), with a light emission window (15) transverse to the optical axis (12), and with a concave inner reflecting surface (14) and an outer surface (4);
an electric lamp (16) positioned in the reflecting portion (11);
a housing (5) accommodating said lamp-reflector unit (2), and accommodating an aperture (6) for enabling light originating from the lamp-reflector unit (2) during operation of the lamp (16) to emit from the housing (5), and accommodating air flow cooling means (7) for cooling of the lamp-reflector unit (2) during operation of the lamp (16), the cooling means (7) comprising a ventilation opening (8) in the housing (5) for enabling cooling air to flow out of the housing (5);
characterized in that the lamp-reflector unit (2) is provided with a shield (9) at a side of the reflecting surface (14) facing away from the light emission window (15) and in between the lamp (16) and the ventilation opening (8).

2. A lighting system according to claim 1, characterized in that the shield is a coating (9) on the outer surface (15) of the reflector body (3).

3. A lighting system according to claim 2, characterized in that the coating (9) is an UV-shielding coating.

4. A lighting system according to claim 2, characterized in that the coating (9) is a black coating.

5. A lighting system according to claim 1, 2, 3 or 4, characterized in that the lighting system (1) is a projector.

6. A lighting system according to claim 5, characterized in that the projector (1) is a light valve projector.

7. A lamp-reflector unit (2) comprising:
a reflector body (3) with a reflecting portion (11) having an optical axis (12), with a light emission window (15) transverse to the optical axis (12), and with a concave inner reflecting surface (14) and an outer surface (4);
an electric lamp (16) positioned in the reflecting portion (11);
characterized in that the lamp-reflector unit (2) is provided with a shield (9) at a side of the reflecting surface (14) facing away from the light emission window (15).

8. A lamp-reflector unit (2) according to claim 7, characterized in that the shield is a coating (9) on the outer surface (15) of the reflector body (3).

9. A lamp-reflector unit (2) according to claim 8, characterized in that the coating (9) is an UV-shielding coating.

10. A lamp-reflector unit (2) according to claim 8, characterized in that the coating (9) is a black coating.
